(19) United States
(12) Patent Application Publication
(10) Pub. No.: US 2026/0202507 A1
(43) Pub. Date: Jul. 16, 2026

(54) Dual-Function Satellite/Radar Communications System

(71) Applicant: Elta Systems Ltd., Ashdod (IL)

(72) Inventors: Itai BAR ZIV, Gedera (IL); Itay FUCHS, Nes Ziona (IL)

(21) Appl. No.: 19/421,178

(22) Filed: Dec. 16, 2025

(30) Foreign Application Priority Data
Dec. 16, 2024 (IL) 317730

(51) Int. Cl. G01S 7/03; H01Q 25/04; H04B 1/44

(52) U.S. Cl. CPC G01S 7/03; H01Q 25/04; H04B 1/44

(57) ABSTRACT

An add-on module enables a SATCOM system to selectively transmit and receive radar signals in addition to SATCOM signals. A circulator has a transmit/receive port and an input port for coupling respectively between a transmit/receive port of the SATCOM orthomode transducer and an output of the SATCOM transmitter amplifier. A low noise radar receiver amplifier has an input port coupled to the output port of the circulator and an output port coupled to the SATCOM receiver. The circulator operates within the frequency range of the SATCOM system and the radar signals, and directs amplified radar and SATCOM transmission signals to the antenna while bypassing the receiver and directs radar signals received from the antenna to the receiver while bypassing the transmitter. The receiver and the transmitter have selectable SATCOM and radar modes configured to transmit and receive at any given time either SATCOM signals or radar signals, respectively.

### FIELD OF THE INVENTION

This invention relates to dual-function satellite communications (SATCOM) and radar systems.

### BACKGROUND OF THE INVENTION

Dual-function radar communication (DFRC) systems have been proposed for optimal exploitation of scare spectrum. For example, reference is made to “Dual-Function Radar Communication Systems: A solution to the spectrum congestion problem” by Aboulnasr Hassanien et al. in IEEE SIGNAL PROCESSING MAGAZINE, September 2019. The article states that one of the most pressing challenges in the area of spectral congestion and dynamic frequency allocation is to provide uncontested shared bandwidth between radar and communications or among various RF systems at large. As such, there is a growing and strong need for new bold concepts for making the use of the radio spectrum more efficient while offering protection from interfering services. The article further observes that this need has spurred extensive efforts to devise ways to simultaneously operate radar target illuminations and wireless services using the same frequency bandwidth, a drive that is commonly referred to as coexistence.

One approach to achieving this objective termed co-design relates to a DFRC system that simultaneously performs radar and communication functions using a common transmit/receive aperture, the same bandwidth, and joint dual-function waveforms. This allows the communication service to capitalize on the resources of the radar infrastructure while striving to be transparent to the radar operation and mission.

It is apparent that the DFRC system disclosed in the above-referenced article takes the radar system as the principal component and adds a communications network as an auxiliary function that embeds information into radar pulses using amplitude-shift keying (ASK), phase-shift keying (PSK), or index modulation (IM), such as code-shift keying (CSK), frequency IM, or spatial modulation. In other words, the radar pulses are modulated in order to allow communication signals to be transmitted and received.

Thus, it is stated that typically, the operating parameters of the radar need to remain fixed within a coherent processing interval (CPI). Communications, being secondary to the primary radar function of the system, can be incorporated by modulating the transmit beampattern, the radar waveforms, or both. In essence, the main lobe is used for the radar communication while the side lobes are used for other communication. Co-existence in multiple-input multiple-output (MIMO) radar systems can be realized using beamforming, namely, by generating multiple beams with different waveforms towards radar targets and communication users at diverse directions. It has also been proposed to allocate a subset of an antenna array to radar and the rest to wireless communications. An alternative approach is disclosed by Tianyao Huang et al. in MAJORCom: A Dual-Function Radar Communication System Using Index Modulation in IEEE TRANSACTIONS ON SIGNAL PROCESSING, VOL. 68, 2020. Known schemes for adding communication functionality to existing radar systems result in some degradation in the functionality of the radar system.

### SUMMARY OF THE INVENTION

It is an object of the present invention to retrofit radar functionality into a SATCOM system in order to provide a dual-function SATCOM/radar system that is configured to transmit either satellite communications or radar through a common antenna.

This object is achieved in accordance with an embodiment of the invention by retro-fitting to a SATCOM system an add-on module having a radar RF circulator and low noise amplifier. In some embodiments, the SATCOM system comprises a software-controlled digital transmitter and receiver, allowing precise configuration and management of signal parameters, including polarization, through a Graphical User Interface (GUI).

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a block diagram showing the functionality of a conventional satellite communications system; and

FIG. 2 is a block diagram showing the functionality of an enhanced satellite communications system having an add-on module that facilitates radar communication.

### DETAILED DESCRIPTION OF EMBODIMENTS

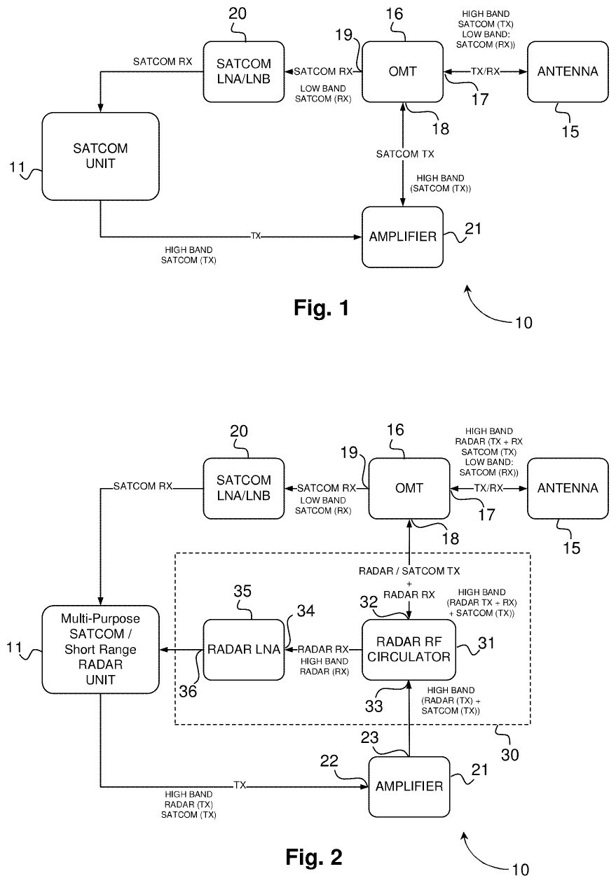

FIG. 1 shows a conventional satellite communications system 10 comprising a SATCOM system 11 having a transmitter 12 configured to transmit high band satellite signals and a receiver 13 configured to receive low band satellite signals. The signals transmitted and received by the transmitter 12 and receiver 13, respectively, have mutually orthogonal first and second polarizations in order to operate at full duplex, whereby transmission and reception may occur simultaneously. Suitable orthogonal polarizations include horizontal and vertical linear polarizations or left-hand (LHCP) and right-hand circular polarizations (RHCP).

An antenna 15 is configured to simultaneously transmit and receive SATCOM signals with respective mutually orthogonal first and second polarizations thus enabling full duplex communication in known manner. An orthomode transducer (OMT) 16 has first and second transmit/receive ports 17 and 18, and a single feed horn 19. The first transmit/receive port 17 is coupled to the antenna 15 for directing high band SATCOM signals at the first polarization to the antenna 15 and for directing low band SATCOM signals received at the antenna 15 at the second polarization to the feed horn 19. A low noise SATCOM receiver amplifier 20 is coupled between the feed horn 19 of the OMT 16 and the receiver 13 of the SATCOM system 11 for amplifying the low band SATCOM signals received by the antenna 15 and conveying amplified signals at the second polarization to the receiver 13 of the SATCOM system. A SATCOM transmitter amplifier 21 has an input 22 and an output 23 coupled respectively between the transmitter 12 of the SATCOM system 11 and the second transmit/receive port 18 of the OMT 16 for conveying an amplified high band signal at the first polarization to the antenna 15.

The OMT 16 separates or combines signals of orthogonal polarizations in a dual-polarized feed system and allows simultaneous transmission and reception of signals with orthogonal polarizations (e.g., vertical and horizontal, or left-hand and right-hand circular polarization) using a single feed horn, maximizing the use of the frequency spectrum. The OMT 16 also provides high isolation between the two polarizations to minimize interference, ensuring that the signals remain distinct. In some cases, OMTs can combine signals of different polarizations for transmission or split them during reception. The OMT 15 ensures that signals transmitted to the satellite and received from the satellite can coexist on the same antenna system without interference, provided they use orthogonal polarizations.

The antenna 15 is a dual-polarized antenna that is commonly a dish antenna and is configured to handle multiple channels or increase data throughput by using orthogonal polarization diversity. By using orthogonal polarizations, it is possible to reuse the same frequency band for both polarizations, effectively doubling the capacity. The OMT 16 uses waveguides, filters, and mechanical structures to separate or combine the orthogonal signals efficiently. Thus, as seen in FIG. 1, a received signal may be conveyed by the feed horn 19 at the same time as a transmitted signal is conveyed by the second transmit/receive port 18 to the antenna 15. For any given SATCOM system 11, the OMT 16 determines the low-band frequency associated with the receiver and the high-band frequency associated with the transmitter.

FIG. 2 is a block diagram showing the functionality of an enhanced satellite communications system 25 having an add-on module 30 that can be retrofitted to a conventional satellite communications system such as described above with reference to FIG. 1 in order to facilitate radar communication. The add-on module 30 comprises a circulator 31 having a circulator transmit/receive port 32 coupled to the second transmit/receive port 18 of the OMT 16, and a circulator input 33 coupled to the output 23 of the SATCOM transmitter amplifier 21. In other words, the circulator 31 is interposed between the SATCOM transmitter amplifier 21 and the second transmit/receive port 18 of the OMT 16. An output port 34 of the circulator 21 is connected to an input 34 of a low noise radar amplifier 35 whose output 36 is coupled to the receiver 13.

The circulator 31 is a passive microwave device that routes signals in a specific directional sequence among its ports. It is used in radar systems to allow the same antenna 15 to be used for both transmitting and receiving, without the transmitted signal interfering with the receiver 13. Radar transmitters produce high-power pulses that can damage the sensitive receiver electronics. The circulator 31 ensures that the high-power transmitted signal is directed to the antenna 15 and not back into the sensitive receiver 13, thus preventing damage. Similarly, it directs the weak received signals from the antenna 15 to the receiver 13, bypassing the transmitter 12. By efficiently managing the signal flow, the circulator facilitates the use of a single antenna for both transmission and reception, simplifying the system design.

The circulator 31 must be matched to the OMT 16 of the SATCOM system 11 to ensure efficient transmission and reception when integrating radar functionality. In some embodiments, the circulator is employed to provide RF isolation between the transmitter and the receiver while permitting both devices to share a common antenna path. When the circulator is used in conjunction with an orthomode transducer (OMT), proper impedance matching and polarization alignment are required to ensure efficient operation and to prevent undesired signal reflections or cross-polarization effects. The circulator and the OMT preferably exhibit substantially identical characteristic impedances, typically 50 ohms. This common impedance minimizes standing waves and reduces insertion losses within the shared RF path. When the inherent impedances of the circulator and OMT differ, an impedance-matching network, such as a quarter-wave transformer, tuning stub, or other impedance transformation circuitry, may be introduced between the devices. The voltage standing wave ratio (VSWR) at the interconnection points may be measured using RF test equipment to confirm that the impedance mismatch is within acceptable limits and that signal reflection remains minimal.

The circulator must be capable of operating across the combined frequency ranges utilized by the SATCOM and radar subsystems. Accordingly, the circulator is selected with a bandwidth encompassing both the SATCOM operating band and the radar transmit and receive frequencies. The selected bandwidth is further verified to ensure compatibility with the OMT, which must present acceptable insertion loss and isolation across the same frequency range. The OMT separates or combines signals according to their orthogonal polarization components. To preserve polarization purity, the circulator must accommodate these components without inducing significant cross-polarization interference. In some embodiments, the physical arrangement of the circulator ports is aligned with the polarization axes defined by the OMT. Cross-polarization isolation may be measured to confirm that leakage between orthogonal polarization channels is maintained within design limits.

Integration begins with identification of the operational frequency bands and polarization modes required by both the SATCOM and radar subsystems. The anticipated transmit and receive power levels are also determined to verify that the circulator possesses sufficient power-handling capability and will not experience overload or saturation during operation. A wideband circulator is selected whose operational frequency range spans the combined SATCOM and radar frequencies. The circulator's power rating, isolation performance, and insertion loss are evaluated to confirm suitability for use within a shared transmitter/receiver path.

The OMT transmit/receive port is coupled to the corresponding circulator port using low-loss coaxial or waveguide transmission lines with appropriately matched connectors. Impedance matching between the OMT and the circulator is verified using a network analyzer, and any mismatch may be corrected using matching circuitry. The circulator's output port is coupled to a low-noise radar amplifier through suitable transmission lines selected to maintain proper impedance. The amplifier is chosen or adjusted to match the circulator's output impedance to ensure optimal signal transfer and reduced reflection.

Following assembly, system performance parameters, including isolation, insertion loss, and return loss, are measured using network-analysis equipment. Should any measured parameter fall outside specification, the matching network or mechanical configuration may be adjusted to improve overall system performance and impedance continuity. High isolation is desirable to prevent radar transmit energy from entering the SATCOM receiver path and to prevent SATCOM emissions from coupling into the radar receiver. The isolation between the OMT ports and the circulator ports may therefore be verified during testing. Because radar transmitters typically operate at significantly higher power levels than SATCOM transmitters, the circulator must be selected to handle the radar's peak transmit power safely.

In some embodiments, the radar subsystem may require operational characteristics, such as polarization state or bandwidth, that differ from those required by the SATCOM subsystem. Such differences may be accommodated through the use of reconfigurable or tunable RF hardware. High-power circulators may dissipate heat due to insertion loss; therefore, appropriate heat-management measures may be incorporated to preserve performance stability and device reliability.

### Example Configuration

In an exemplary arrangement, the OMT provides two distinct output ports corresponding to horizontal and vertical polarization components. The circulator is incorporated such that its transmit port receives either a SATCOM transmit signal or a radar transmit pulse. Its common port is connected to the antenna via the OMT, and its receive port is directed to the SATCOM or radar receiver, depending on the operating mode. System verification may be performed using representative radar bursts and SATCOM waveforms to confirm correct routing, isolation, and signal integrity.

The transmitter 12 and the receiver 13 are preferably software-controlled digital devices, allowing precise configuration and management of signal parameters, including polarization, through a Graphical User Interface (GUI). This avoids the need to retrofit a separate radar transmitter and receiver into the SATCOM system 11, since the parameters of the transmitter 12 and receiver 13 can be adjusted under software control to allow them to transmit and receive either SATCOM signals or radar signals. It should be noted that since it is required to transmit and receive SATCOM signals simultaneously, the transmitted and received signals must be of orthogonal polarization. However, in the case of radar communication, a radar pulse is transmitted to a target prior to its being reflected by the target and returned as a received signal. Therefore, half duplex communication is sufficient and the transmitted and received radar signals do not require any special polarization. Likewise, unlike SATCOM for which the transmitted signals are high band and the received signals are low band in order to ensure proper isolation, in the case of radar both transmitted and received pulses are high band. This allows the radar signals to be directed by the OMT 16 to the antenna in the same way as the SATCOM signals without the need for adjustment of the OMT or the antenna. The received radar signals being also high band will not be directed by the OMT 16 to the feed horn 19 but will be directed instead to the circulator 31.

In certain embodiments, the SATCOM system may employ software-defined radios (SDRs) or digital signal processors (DSPs) to provide flexible signal processing capabilities. The system may include a digital baseband processor configured to perform modulation and demodulation of SATCOM signals and to permit real-time adjustment of waveform characteristics under software control. An RF front end may convert baseband signals to the required RF transmission frequency, and may likewise convert received RF signals to baseband for subsequent processing. One or more control interfaces may be provided for managing RF operational parameters such as frequency, output power, bandwidth, and polarization.

Digital SATCOM implementations permit the generation and control of polarization states through programmable hardware. Linear polarization may be produced by routing the signal to particular antenna elements, such as horizontal or vertical ports, in response to software commands. Circular polarization may be produced by generating two orthogonal linear components with a controlled 90° phase offset, such offset being implemented by digital phase shifters and combiners operative within the RF signal chain. Polarization states may be switched responsively to user commands, wherein a graphical user interface (GUI) issues software instructions that reconfigure antenna feed paths, adjust phase shifters, or select alternate RF chain ports to effect a transition from one polarization mode to another, such as from horizontal to vertical or from right-hand circular polarization (RHCP) to left-hand circular polarization (LHCP).

A GUI may provide an operational interface through which the user interacts with the SATCOM system. The GUI may display the current polarization state and may furnish real-time performance data, including bit error rate, signal-to-noise ratio, or other relevant metrics. The GUI may permit the user to select a desired polarization through menus, buttons, or other selectable fields, and the resulting settings may be transmitted to the system's control software for execution by the underlying hardware. The GUI may additionally allow storage and retrieval of preset configurations that include predetermined polarization settings.

User interaction may proceed by selecting a desired polarization state, whereupon the GUI issues one or more commands to the system's software layer. The software may then communicate with the hardware components, adjusting the antenna feed network or phase-shift configuration. The GUI may subsequently update the displayed metrics to provide confirmation that the requested polarization change was successfully implemented.

Communication between the GUI and the hardware may occur through one or more control protocols. These may include standard interfaces such as SNMP, RS-232, or IP-based application programming interfaces, as well as proprietary command sets for controlling polarization-related parameters. Embedded firmware executing on the SATCOM hardware may interpret the received commands and actuate elements such as orthomode transducers (OMTs), digital phase shifters, or antenna elements to achieve the commanded polarization state.

The use of a GUI for polarization control may offer various advantages. User flexibility is enhanced, as polarization may be adjusted rapidly to accommodate changes in satellite alignment or link requirements. Ease of use is increased by the intuitive GUI environment, reducing the need for specialized technical training. Remote operation may be supported through network-based interfaces, enabling polarization adjustment from remote locations. Real-time system feedback further permits the user to verify the effectiveness of any changes.

An exemplary workflow may involve initiating the SATCOM control GUI on a computing device, observing the current polarization state, selecting a new polarization such as a transition from RHCP to LHCP, and applying the change through an on-screen command. Upon system confirmation, the user may monitor updated performance metrics, including signal strength or cross-polarization isolation, to confirm the success of the adjustment.

Advanced functionality may include automated polarization switching in response to satellite commands or environmental factors, as well as fine-tuning of cross-polarization isolation through incremental phase adjustments implemented via the GUI.

By integrating these capabilities, the SATCOM system 11 with GUI-controlled digital devices can provide user-friendly and precise control of polarization, enhancing system performance and operational flexibility. It can also seamlessly change the configuration of the SATCOM system 11 to allow the same system to be employed for both satellite communication and radar without the need to modify the SATCOM system 11 and with the addition of the circulator 31 and low noise amplifier 35.

For the sake of completeness, it will be appreciated that separate transmitters and receivers can be provided for SATCOM and radar, each configured to transmit and receive appropriate signals. In this case, selection of the required mode of operation can be via a simple selector switch or via a software interface, although mode selection does not need to adjust signal parameters since they are preconfigured in hardware.

Finally, although the invention has been described with particular reference to an add-on module that can be retrofitted to an existing SATCOM system, it will be appreciated that the invention also embraces an integrated system having the features as described.

1. An add-on module for enabling a satellite communications system to selectively transmit and receive radar signals in addition to SATCOM signals;
wherein the satellite communications system comprises:
a SATCOM system having a transmitter configured to transmit high band SATCOM signals and a receiver for receiving low band SATCOM signals, wherein the high band and low band signals have mutually orthogonal first and second polarizations,
an antenna for simultaneously receiving and transmitting the low band and high band SATCOM signals,
an orthomode transducer having a first transmit/receive port, a second transmit/ receive port and a feed horn,
the first transmit/receive port being coupled to the antenna for directing high band SATCOM signals at the first polarization to the antenna and for directing low band SATCOM signals received at the antenna at the second polarization to the feed horn,
a low noise SATCOM amplifier coupled between the feed horn of the orthomode transducer and the receiver of the SATCOM system for amplifying the low band SATCOM signal received by the antenna and conveying an amplified signal at the second polarization to the receiver, and
a SATCOM transmitter amplifier having an input and an output coupled respectively between the transmitter of the SATCOM system and the second transmit/receive port of the orthomode transducer for conveying an amplified high band signal at the first polarization to the antenna; and
wherein the add-on module comprises:
a circulator having a circulator transmit/receive port and a circulator input port for coupling respectively between the second transmit/receive port of the orthomode transducer and the output of the SATCOM transmitter amplifier, and
a low noise radar receiver amplifier having a radar amplifier input port coupled to the output port of the circulator and a radar amplifier output port coupled to the receiver;
the circulator being configured to operate within the frequency range of the SATCOM system and the radar signals, and to direct amplified radar and SATCOM transmission signals to the antenna while bypassing the receiver and to direct radar signals received from the antenna to the receiver while bypassing the transmitter; and
the receiver and the transmitter having selectable SATCOM and radar modes configured to transmit and receive at any given time either SATCOM signals or radar signals, respectively.

2. An integrated satellite communications system configured to selectively transmit and receive radar signals or SATCOM signals, the system comprising:
a SATCOM system having a transmitter configured to transmit high band SATCOM signals and a receiver for receiving low band SATCOM signals, wherein the high band and low band signals have mutually orthogonal first and second polarizations,
an antenna for simultaneously receiving and transmitting the low band and high band SATCOM signals,
an orthomode transducer having a first transmit/receive port, a second transmit/receive port and a feed horn,
the first transmit/receive port being coupled to the antenna for directing high band SATCOM signals at the first polarization to the antenna and for directing low band SATCOM signals received at the antenna at the second polarization to the feed horn,
a low noise SATCOM amplifier coupled between the feed horn of the orthomode transducer and the receiver of the SATCOM system for amplifying the low band SATCOM signal received by the antenna and conveying an amplified signal at the second polarization to the receiver,
a SATCOM transmitter amplifier having an input and an output coupled respectively between the transmitter of the SATCOM system and the second transmit/receive port of the orthomode transducer for conveying an amplified high band signal at the first polarization to the antenna,
a circulator having a circulator transmit/receive port and a circulator input port for coupling respectively between the second transmit/receive port of the orthomode transducer and the output of the SATCOM transmitter amplifier, and
a low noise radar receiver amplifier having a radar amplifier input port coupled to the output port of the circulator and a radar amplifier output port coupled to the receiver;
the circulator being configured to operate within the frequency range of the SATCOM system and the radar signals, and to direct amplified radar and SATCOM transmission signals to the antenna while bypassing the receiver and to direct radar signals received from the antenna to the receiver while bypassing the transmitter; and
the receiver and the transmitter having selectable SATCOM and radar modes configured to transmit and receive at any given time either SATCOM signals or radar signals, respectively.

3. The system according to claim 2, wherein the transmitter and receiver are software-controlled digital devices, allowing configuration and management of signal parameters, including polarization, through a Graphical User Interface (GUI).
